(19) United States
(12) Patent Application Publication
(10) Pub. No.: US 2010/0100210 A1
(43) Pub. Date: Apr. 22, 2010

(54) ARITHMETIC-LOGIC UNIT FOR DIGITAL SIGNAL PROCESSOR

(75) Inventors: Alessandro Mecchia, Milano (IT); Carlo Pinna, Milano (IT)

Correspondence Address: SEED INTELLECTUAL PROPERTY LAW GROUP PLLC, 701 FIFTH AVENUE, SUITE 5400, SEATTLE, WA, 98104-7092, US

(73) Assignee: ST ERICSSON SA, Geneva (CH)

(21) Appl. No.: 12/604,319

(22) Filed: Oct. 22, 2009

(30) Foreign Application Priority Data
Oct. 22, 2008 (IT) BS2008A000185

(51) Int. Cl. G06F 17/00

(52) U.S. Cl. 700/94

(57) ABSTRACT

An arithmetic-logic unit for a digital signal processor, processing audio signals, having a multiplier circuit able to receive in input a first and a second signal and to supply in output a third signal which represents the result of the multiplication of said first and second signal, a generator circuit of a dither signal, a summation circuit downline of the multiplier circuit, said summation circuit being able to perform an addition operation between said third signal and the dither signal so as to supply a fourth signal in output, and a truncation or rounding circuit downline of the summation circuit, able to truncate or round said fourth signal.

### BACKGROUND

1. Technical Field

The present disclosure relates to an arithmetic-logic unit (ALU) for digital signal processor (DSP), specifically for processing audio signals.

2. Description of the Related Art

With reference to FIG. 1, showing a functional block example of part of an arithmetic-logic unit dedicated to performing an operation which comprises a multiplication, the performance of such multiplication operation between two operands, B, of n bit and C, of m bit, generates a result M of n+m−1 bit. Since the result of the instruction Z must normally be registered or stored in a register or memory location, the word length of which is less than n+m bit, a certain number of bits have to be discarded from the result by rounding or truncation of the less significant bit (normally the result Z is n bit, so that the less significant m−1 bit must be discarded).

The content of the discarded, less significant m−1 bit is not normally accessible and cannot be used by subsequent instructions.

In digital processing of signals by a DSP, the truncation or rounding performed in the ALU at each multiplication operation generates a distortion of the signal. The filtering, and more generally signal processing algorithms, generally entail a significant number of multiplications and truncations of the signal. Specifically, an FIR filter entails a number of multiplications proportional to the number of coefficients, while an IIR filter entails a theoretically infinite number of multiplications.

In the latter case, as well as distortion, the non-linearity introduced by the truncation may give rise to limit cycles and to the generation of spur tones even in the absence of variation of the input signal.

By adding an appropriate noise (known as “dither”) before performing truncation, a “linearization” of the truncation may be achieved, thereby avoiding distortion of the signal. This is counterbalanced by an increase in the correlated basic noise which however, especially in the case of acoustic signals, proves less psycho-acoustically disturbing to the ear than the distortion. For IIR filters, in addition, the linearity permits the elimination of limit cycles.

Since the entire word length of the result of multiplication is not normally available for subsequent processing, the solutions generally adopted entail the use of algorithms which increase the precision of the operations, if possible making use of the longer word length of the accumulator, or of the DSP, which has a considerably longer word length than that of the signal. This way the truncation remains confined to the less significant bit at negligible levels in relation to the signal dynamics. At the end of the processing, since the word size of the signal must be restored, an explicit addition of the dither and truncation of the final result of processing is performed.

For example, a typical sizing using this solution is that in which an input and output signal of 24 effective bits corresponds to the use of a 32 bit, fixed-point DSP. Considering, for example, assigning 3 bits to internal dynamics, the input signal will initially be multiplied by 2̂5 leaving 5 less significant bits to contain the distortions caused by truncation. At the end of 32 bit processing, these 5 less significant bits will be discarded from the final result, after having added an appropriate dither, dividing the signal by 2̂5 (in this example the dither has a 5 or 6 bit word, depending on whether its Probability Density Function or “PDF” is rectangular or triangular.

### BRIEF SUMMARY

An embodiment seeks to address the problems caused by non-linearity of the truncation or rounding operation intrinsic to every multiplication operation performed in an ALU, but without the need to use algorithms which increase the precision of the operations and/or the use of DSP with word lengths significantly longer than that of the signal.

In an embodiment, an arithmetic-logic unit to process audio signals comprises: a multiplier configured to receive in input a first and a second signal and to supply in output a third signal which is the result of the multiplication of the first and second signals; a dither generator configured to generate a dither signal; an adder coupled to an output of the multiplier and configured to sum the third signal and the dither signal and to supply in output a fourth signal; and a bit reducer coupled to an output of the adder and configured to truncate or round the fourth signal. In an embodiment, the arithmetic-logic unit has a set word width, and the dither generator is configured to generate the dither signal with a word width equal or greater by one unit, to a number of bits which the third signal has in excess of the set word width. In an embodiment, the adder is configured to align the dither signal to a least significant bit of the third signal. In an embodiment, the dither signal has a rectangular, uniform distribution. In an embodiment, the dither signal has a triangular distribution. In an embodiment, the bit reducer supplies in output a fifth signal having a word width equal to a set word width of the arithmetic-logic unit.

In an embodiment, a digital signal processor to process audio signals comprises: a multiplier configured to receive in input a first and a second signal and to supply in output a third signal which is the result of the multiplication of the first and second signals; a dither generator configured to generate a dither signal; an adder coupled to an output of the multiplier and configured to sum the third signal and the dither signal and supply in output a fourth signal; and a bit reducer coupled to an output of the adder and configured to truncate or round the fourth signal. In an embodiment, the processor is configured to execute a portion of code containing at least one multiplication instruction and execution of the multiplication instruction includes causing the adder to sum the third signal and the dither signal. In an embodiment, execution of the multiplication instruction includes causing the bit reducer to truncate or round the fourth signal.

In an embodiment, a method of processing digital signals using a digital signal processor comprises: multiplying, using the digital signal processor, a first digital signal and a second digital signal to produce a product; adding, using the digital signal processor, a dither signal to the product to produce a sum having a number of bits; and truncating or rounding, using the digital signal processor, the sum to produce an output having a number of bits less than the number of bits of the sum. In an embodiment, adding the dither signal to the product is automatically performed when the multiplication operation is performed. In an embodiment, the dither signal is a null signal.

In an embodiment, an arithmetic-logic unit comprises: a multiplier configured to multiple a first and a second signal to produce a product; a dither generator configured to generate a dither signal; an adder configured to add the product and the dither signal to produce a sum having a number of bits; and a bit reducer configured to reduce a number of least significant bits of the sum to produce an output having a number of bits less than the number of bits of the sum. In an embodiment, the bit reducer is configured to produce the output by truncating the sum. In an embodiment, the bit reducer is configured to produce the output by rounding the sum. In an embodiment, the arithmetic-logic unit has a fixed word width, and the dither generator is configured to generate the dither signal with a word width equal or greater by one unit, to a number of bits which the product has in excess of the fixed word width. In an embodiment, the adder is configured to align the dither signal to a least significant bit of the product. In an embodiment, the dither signal has a rectangular distribution. In an embodiment, the bit reducer supplies in output a signal having a word width equal to a fixed word width of the arithmetic-logic unit.

In an embodiment, a system to process digital audio signals comprises: a multiplier configured to multiple first and second signals to produce a product; a dither generator configured to generate a dither signal; an adder configured to add the product and the dither signal to produce a sum having a number of bits; and a bit reducer configured to reduce a number of least significant bits in the sum. In an embodiment, the system comprises at least one processor configured to execute a portion of code containing at least one multiplication instruction, wherein execution of the multiplication instruction includes causing the adder to add the product and the dither signal. In an embodiment, execution of the multiplication instruction further includes causing the bit reducer to reduce the number of least significant bits in the sum.

In an embodiment, a method of processing digital signals using a digital signal processor comprises: multiplying, using the digital signal processor, a first digital signal and a second digital signal to produce a product; adding, using the digital signal processor, a dither signal to the product to produce a sum having a number of bits; and reducing, using the digital signal processor, a number of least significant bits in the sum to produce an output having a number of bits less than the number of bits of the sum. In an embodiment, the reducing comprises truncating the sum. In an embodiment, the reducing comprises rounding the sum. In an embodiment, the dither signal is a null signal.

In an embodiment, a tangible computer-readable medium's contents cause at least one digital signal processor to perform a method, the method comprising: multiplying a first digital signal and a second digital signal to produce a product; adding a dither signal to the product to produce a sum having a number of bits; and reducing a number of least significant bits in the sum to produce an output having a number of bits less than the number of bits of the sum. In an embodiment, the reducing comprises rounding the sum. In an embodiment, the adding comprises aligning the dither signal with a least significant bit of the product.

### BRIEF DESCRIPTION OF THE SEVERAL VIEWS OF THE DRAWINGS

Further characteristics and advantages of embodiments of arithmetic logic units according to the disclosure will be more evident from the description below, made by way of a non-limiting example, of some preferred embodiments with reference to the attached figures, wherein:

FIG. 1 is a schematic illustration of the fixed-point part of an ALU dedicated to performing a multiplication instruction according to the known technique;

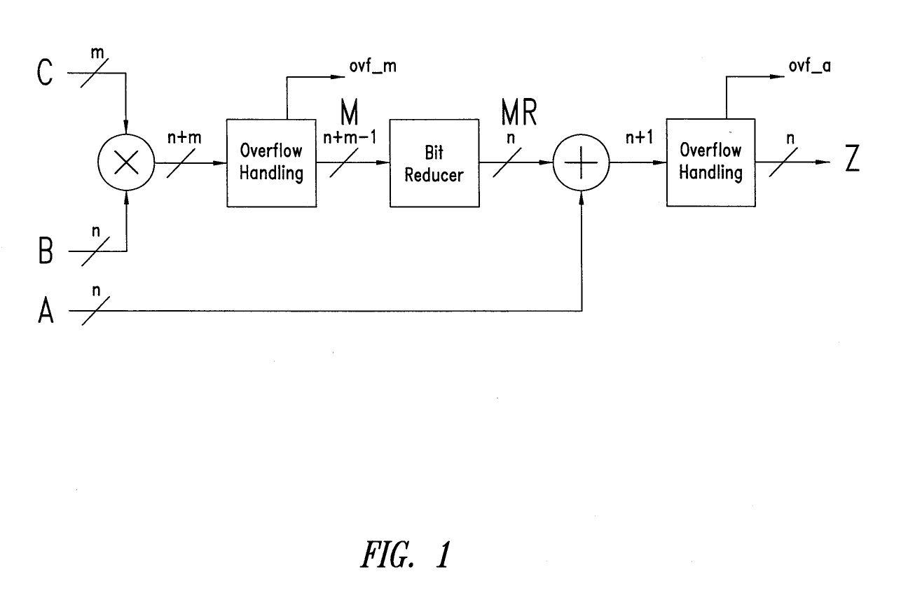

FIG. 2 is a schematic illustration of the fixed-point part of an ALU dedicated to performing a multiplication instruction according to the present invention;

FIG. 3 is an example of an ALU of a DSP according to the invention;

FIG. 4 shows the spectrum of a sinusoid processed in a DSP with an ALU according to the invention; and

FIG. 5 shows the spectrum of a sinusoid processed in a DSP with a traditional ALU.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the embodiments.

Reference throughout this specification to “one embodiment” or “an embodiment” means that a particular feature, structure, or characteristic described in connection with the embodiment is included in at least one embodiment. Thus, the appearances of the phrases “in one embodiment” “according to an embodiment” or “in an embodiment” and similar phrases in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the embodiments.

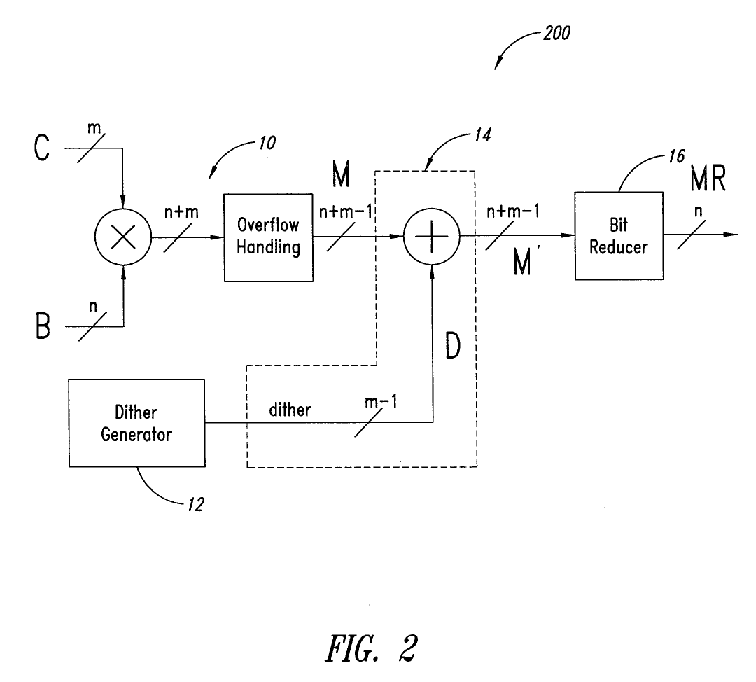

With reference to FIG. 2, an embodiment of an arithmetic-logic unit (ALU) for a digital signal processor (DSP), for example for processing audio signals, comprises:
a multiplier 10 able to receive a first signal B and a second signal C in input and to supply in output a third signal M which is the result of the multiplication of said first and second signal;
a dither generator 12 of a dither signal D;
a summation circuit or adder 14 downline of the multiplier 10, said summation circuit 14 being able to perform an addition operation between said third signal M (result of the multiplication) and the dither signal D, so as to supply in output a fourth signal M′; and
a bit reducer 16 downline of the summation circuit, configured to reduce a number of least significant bits in the fourth signal M′, so as to supply in output a fifth signal MR available for the other blocks of the ALU. The bit reducer 16 may be configured, for example, to reduce the number of bits by truncating or rounding the fourth signal. As illustrated the multiplier 10 comprises an overflow handler 11 configured to determine when the third signal exceeds m+n−1 bits.

As recalled above, dither signal is taken to mean a noise signal with a suitable distribution, which is voluntarily added to digital signals so as to minimize the distortion introduced by truncation or rounding in the case in which the said signals are re-quantized.

According to one embodiment, given a set word width for the arithmetic-logic unit, which may be a pre-set word width, the dither signal has a word width equal, or greater by one unit, to the number of bits which the third signal M, result of the multiplication, has in excess of said set word length.

In the example embodiment of an ALU 200 shown in FIG. 2, it is presumed that the ALU has a word width of n bit, and that the two operands B and C are respectively of n and m bit. The third signal M, result of the multiplication, is of n+m−1 bits, with a possible overflow. Consequently, the bits in excess of the word length of the ALU are m−1. The dither signal D therefore has a word length of m−1 bit, or m bit, depending on the probability density function of the dither signal. The summation circuit or adder 14 is configured to align the dither signal D with the least significant bit of the third signal M.

According to one embodiment, the dither signal D has a rectangular, uniform distribution.

In another embodiment, the dither signal D has a triangular distribution, that is derived from the convolution of two rectangular, uniform dithers.

The bit reducer 16 is configured to supply a fifth signal in output, MR, having a word width equal to that set for the arithmetic-logic unit.

As a result, a suitable dither D is implicitly and automatically added to the result of the multiplication inside the ALU itself, before the truncation or rounding. In other words, in the ALU according to an embodiment, the summing operation of the dither and the subsequent truncation or rounding of the word is automatically performed at the same time as the performance of the multiplication. No register or accumulator is therefore needed to access the n+m−1 bit result of the multiplication, precisely because the dithering and truncation operations are considered a single operation: the dither is added solely for the sake of the subsequent truncation and the useful data is that at n bit available after truncation.

In yet other terms, in an embodiment a programmer who programs the digital signal processor code has no need to compile a special instruction to use the dithering function. In fact, the multiplication instruction automatically also produces the summation operation of the result of the multiplication and the dither signal.

Advantageously, every multiplication instruction may also automatically comprise a truncation or rounding operation of the sum signal.

The arithmetic-logic unit (ALU) according to an embodiment makes it possible to use in the ALU a word length slightly greater than that corresponding to the performance required, specifically for an audio signal, with a significant saving in the number of circuit elements (and therefore silicon area) and consumption, at the same performance.

In addition, in an embodiment the linearization of the signal obtained makes it possible to create limit cycle-free type IIR filters without the need to add a dither to the input signal.

It is worth noting that, advantageously, in an embodiment the use of a traditional ALU may be simulated, for example if a deterministic result is needed, by merely attributing the dither signal an identically null code, in other words, composed of zeroes, and without making any circuit modifications.

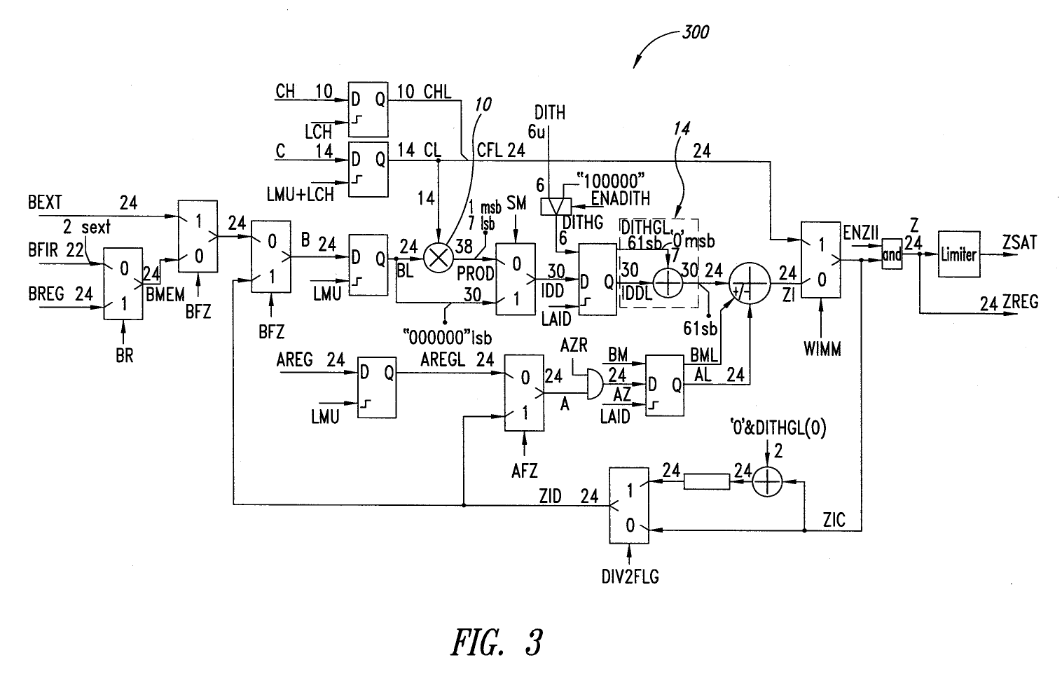

FIG. 3 shows an example of embodiment of a DSP 300 dedicated to the channel filtering needed in the case of up and down-sampling for driving a respective digital-analogical converter (DAC) and analogical-digital converter (ADC) up-sampled. The DSP and its fixed point ALU according to the invention have a word width of 24 bits (n=24), while the audio signal in input and in output is 21 bits (3 bits are left for the dynamics).

The proposed embodiment, which permits a reduction of consumption and area without relinquishing high level performance, is particularly useful for battery powered applications such as mobile phones, MP3 players and PDA.

In FIG. 3 the adder 14 of the dither downline of the multiplier 10 inside the ALU is highlighted. Other components in the ALU include registers and multiplexers. The linearity of the single truncation operation in this example is 30 bits, which corresponds to the number of bits of the result of the multiplication which the dither is added to, before truncation. The type of dither used is rectangular and of a width 6 bits less significant than 30 bits.

With reference to FIG. 3, the supplementary bus, the multiplexers, the registers and other components are used in connection with performing the various arithmetic instructions of the DSP with the correct timing (such as ADD, SUB, MUL, MAC etc.).

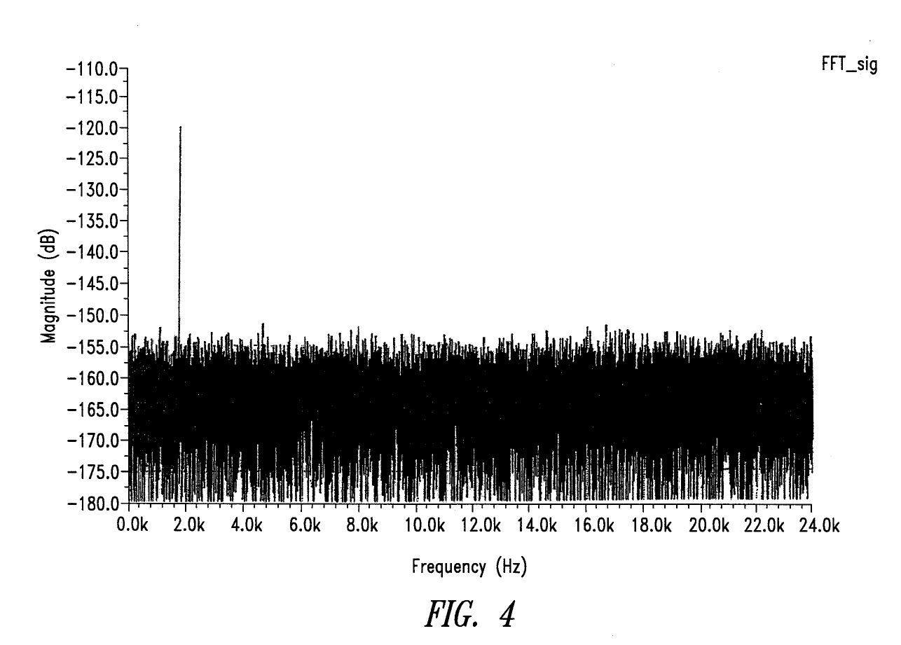

The graph in FIG. 4 shows a filtering chain which performs a down-sampling by four with a band attenuation of 70 dB; the sampling frequency of the data in output is 48 kHz. The chain includes three symmetrical FIR filters, for a total of 42 multiplications performed by the ALU. The input signal is a sinusoid frequency of 1675 Hz and breadth—120 dB. As can be seen from the level of basic noise and absence of lines, overall linearity is at least 25 bits.

To achieve this performance with a traditional ALU a word of at least 28 bits would be needed and therefore the entire ALU and registers would need to be 28 or more bits.

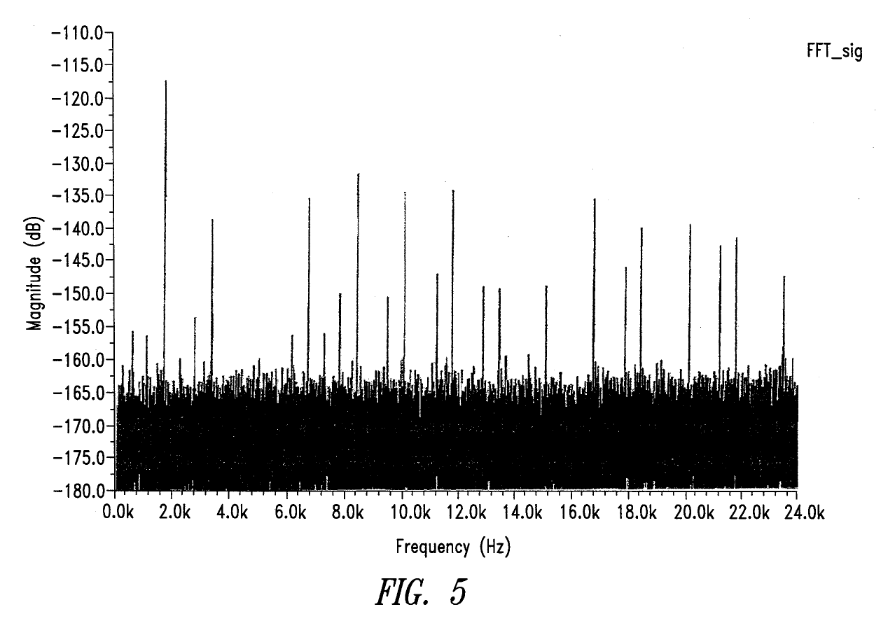

FIG. 5 shows the same spectrum obtained with the same signal and again using a 24 bit ALU but without dithering. As may be seen the basic noise produced by the dithering is absent but there are numerous lines all over the spectrum, indicators of distortions.

A person skilled in the art may make modifications, adaptations and replacements of elements with others functionally equivalent to the embodiments described above so as to satisfy contingent requirements while remaining within the scope of protection of the following claims. Each of the characteristics described as pertaining to a possible embodiment may be realized independently of the other embodiments described.

The foregoing detailed description has set forth various embodiments of the devices and/or processes via the use of block diagrams and examples. Insofar as such block diagrams and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). In one embodiment, the present subject matter may be implemented via one or more digital signal processors executing, for example, instructions stored on one or more memories. However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any computer-readable medium for use by or in connection with any processor-related system or method. In the context of this disclosure, a memory is a computer-readable medium that is an electronic, magnetic, optical, or other physical device or means that contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any element that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape. Note that the computer-readable medium could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An arithmetic-logic unit to process audio signals, comprising:
a multiplier configured to receive in input a first and a second signal and to supply in output a third signal which is the result of the multiplication of the first and second signals;
a dither generator configured to generate a dither signal;
an adder coupled to an output of the multiplier and configured to sum the third signal and the dither signal and to supply in output a fourth signal; and
a bit reducer coupled to an output of the adder and configured to truncate or round the fourth signal.

2. The arithmetic-logic unit according to claim 1 wherein the arithmetic-logic unit has a set word width, and the dither generator is configured to generate the dither signal with a word width equal or greater by one unit, to a number of bits which the third signal has in excess of the set word width.

3. The arithmetic-logic unit according to claim 1 wherein the adder is configured to align the dither signal to a least significant bit of the third signal.

4. The arithmetic-logic unit according to claim 1 wherein the dither signal has a rectangular, uniform distribution.

5. The arithmetic-logic unit according to claim 1 wherein the dither signal has a triangular distribution.

6. The arithmetic-logic unit according to claim 1 wherein the bit reducer supplies in output a fifth signal having a word width equal to a set word width of the arithmetic-logic unit.

7. A digital signal processor to process audio signals, comprising:
a multiplier configured to receive in input a first and a second signal and to supply in output a third signal which is the result of the multiplication of the first and second signals;
a dither generator configured to generate a dither signal;
an adder coupled to an output of the multiplier and configured to sum the third signal and the dither signal and supply in output a fourth signal; and
a bit reducer coupled to an output of the adder and configured to truncate or round the fourth signal.

8. The digital signal processor according to claim 7 wherein the processor is configured to execute a portion of code containing at least one multiplication instruction and execution of the multiplication instruction includes causing the adder to sum the third signal and the dither signal.

9. The digital signal processor according to claim 8 wherein execution of the multiplication instruction includes causing the bit reducer to truncate or round the fourth signal.

10. A method of processing digital signals using a digital signal processor, the method comprising:
multiplying, using the digital signal processor, a first digital signal and a second digital signal to produce a product;
adding, using the digital signal processor, a dither signal to the product to produce a sum having a number of bits; and
truncating or rounding, using the digital signal processor, the sum to produce an output having a number of bits less than the number of bits of the sum.

11. The method of processing according to claim 10 wherein adding the dither signal to the product is automatically performed when the multiplication operation is performed.

12. The method of claim 11 wherein the dither signal is a null signal.

13. An arithmetic-logic unit, comprising:
a multiplier configured to multiple a first and a second signal to produce a product;
a dither generator configured to generate a dither signal;
an adder configured to add the product and the dither signal to produce a sum having a number of bits; and
a bit reducer configured to reduce a number of least significant bits of the sum to produce an output having a number of bits less than the number of bits of the sum.

14. The arithmetic-logic unit of claim 13 wherein the bit reducer is configured to produce the output by truncating the sum.

15. The arithmetic-logic unit of claim 13 wherein the bit reducer is configured to produce the output by rounding the sum.

16. The arithmetic-logic unit of claim 13 wherein the arithmetic-logic unit has a fixed word width, and the dither generator is configured to generate the dither signal with a word width equal or greater by one unit, to a number of bits which the product has in excess of the fixed word width.

17. The arithmetic-logic unit of claim 13 wherein the adder is configured to align the dither signal to a least significant bit of the product.

18. The arithmetic-logic unit of claim 13 wherein the dither signal has a rectangular distribution.

19. The arithmetic-logic unit of claim 13 wherein the bit reducer supplies in output a signal having a word width equal to a fixed word width of the arithmetic-logic unit.

20. A system to process digital audio signals, comprising:
means for multiplying first and second signals to produce a product;
means for generating a dither signal;
means for adding the product and the dither signal to produce a sum having a number of bits; and
means for reducing a number of least significant bits in the sum.

21. The system of claim 21 wherein the system comprises at least one processor configured to execute a portion of code containing at least one multiplication instruction, wherein execution of the multiplication instruction includes causing the adder to add the product and the dither signal.

22. The system of claim 21 wherein the means for multiplying comprises an overflow handler configured to determine when the product exceeds a number of bits.

23. A method of processing digital signals using a digital signal processor, the method comprising:
multiplying, using the digital signal processor, a first digital signal and a second digital signal to produce a product;
adding, using the digital signal processor, a dither signal to the product to produce a sum having a number of bits; and
reducing, using the digital signal processor, a number of least significant bits in the sum to produce an output having a number of bits less than the number of bits of the sum.

24. The method of claim 23 wherein the reducing comprises truncating the sum.

25. The method of claim 23 wherein the reducing comprises rounding the sum.

26. The method of claim 23 wherein the dither signal is a null signal.

27. A tangible computer-readable medium whose contents cause at least one digital signal processor to perform a method, the method comprising:
multiplying a first digital signal and a second digital signal to produce a product;
adding a dither signal to the product to produce a sum having a number of bits; and
reducing a number of least significant bits in the sum to produce an output having a number of bits less than the number of bits of the sum.

28. The computer-readable medium of claim 27 wherein the reducing comprises rounding the sum.

29. The computer-readable medium of claim 27 wherein the adding comprises aligning the dither signal with a least significant bit of the product.
